(19) United States
(12) Patent Application Publication
(10) Pub. No.: US 2023/0221095 A1
(43) Pub. Date: Jul. 13, 2023

(54) Compact Rangefinder Scope

(71) Applicant: Giant Eagle LLC, Arcadia, CA (US)

(72) Inventors: Hong Zhou, Arcadia, CA (US); Yusong Zhou, Arcadia, CA (US)

(73) Assignee: Giant Eagle LLC, Arcadia, CA (US)

(21) Appl. No.: 18/092,917

(22) Filed: Jan. 3, 2023

Related U.S. Application Data
(60) Provisional application No. 63/297,693, filed on Jan. 7, 2022.

(51) Int. Cl. F41G 3/06; F41G 1/38; G02B 27/30; G02B 23/02

(52) U.S. Cl. CPC F41G 3/065; F41G 1/38; G02B 27/30; G02B 23/02

(57) ABSTRACT

A rangefinder scope crossbows and other firearms includes an emitter assembly for transmitting radiant energy toward a target, a first collimating lens assembly for receiving and collimating the reflected radiant energy, a prism assembly optically connected to the first collimating lens assembly for receiving the collimated reflected radiant energy, and a receiver assembly in optical communication with the prism assembly for detecting the radiant energy reflected by the target to thereby calculate a distance between the rangefinder scope and the target. A third collimating lens assembly associated with the emitter further increases accuracy of the scope.

### BACKGROUND OF THE INVENTION

This invention relates generally to the field of laser rangefinders, and more particularly to a compact laser rangefinder for use with a crossbow, archery bow, firearm, or other projectile launching device.

Laser rangefinders typically measure the distance between a user and a distal target. This is especially important in the sporting and hunting industries where the rangefinder may be mounted to a crossbow, archery bow, firearm, etc., for more accurately determining the aim point between the user and the target.

Prior art laser range finders typically include an emitter that discharges a column of radiant energy toward an intended target and a receiver that detects the radiant energy reflected by the target. The emitter usually comprises a laser device that generates a beam of light in the near-infrared region of the electromagnetic spectrum which cannot be viewed with the naked eye, while the emitter comprises a device for detecting the near-infrared laser beam. The time between emission of the radiant energy and reception of the reflected radiant energy is measured and a distance between the laser rangefinder and the target can be calculated. A telescope can be used in conjunction with the emitter/receiver for confirming the target by an observer. The telescope typically has an adjustably magnifying lens to enlarge the perceived size of the target and more accurately verify when the target has been properly sited in by the laser rangefinder.

However, such prior art laser rangefinder devices have been quite large, bulky, and difficult to use and carry, especially when mounted on a crossbow, archery bow, firearm, or the like. With some prior art devices designed for crossbows, the laser rangefinder can be too long, unwieldy, and expensive for practical implementation.

Accordingly, it would be advantageous to provide a laser rangefinder scope that overcomes one or more disadvantages of the prior art.

### SUMMARY OF THE INVENTION

In accordance with one aspect of the invention, a rangefinder scope includes an emitter assembly for transmitting radiant energy toward a target, a first collimating lens assembly for receiving and collimating the reflected radiant energy, a prism assembly optically connected to the first collimating lens assembly for receiving the collimated reflected radiant energy, and a receiver assembly in optical communication with the prism assembly for detecting the radiant energy reflected by the target to thereby calculate a distance between the rangefinder scope and the target. A third collimating lens assembly associated with the emitter can be provided for further increasing measurement accuracy of the scope.

In accordance with a further aspect of the invention, a method of determining the distance to a distal target includes: emitting radiant energy toward the distal target causing the radiant energy to be reflected therefrom; collimating the reflected radiant energy and ambient light reflected at least by the distal target along a first optical pathway; splitting the columnated reflected radiant energy and the columnated ambient light into a first split light beam and a second spit light beam, respectively; directing the first split light beam along a second optical pathway through an ocular lens for optically viewing at least the distal target; collimating the second split light beam along a third optical pathway; and determining the distance by calculating a time of flight difference between the emitted radiant energy and the reflected radiant energy.

Further aspects of the invention will become apparent as set forth herein along with the accompanying drawings.

### BRIEF DESCRIPTION OF THE DRAWINGS

The foregoing summary as well as the following detailed description of the preferred embodiments of the present invention will be best understood when considered in conjunction with the accompanying drawings, wherein like designations denote like elements throughout the drawings, and wherein:

FIG. 1 is a front perspective view of a rangefinder scope with representative dimensions to show the compact size in accordance with an exemplary embodiment of the invention;

FIG. 2 is a front elevational view of the rangefinder scope of FIG. 1;

FIG. 3 is a rear elevational view thereof;

FIG. 4 is a right side elevational view thereof;

FIG. 5 is a left side elevational view thereof;

FIG. 6 is a top plan view thereof;

FIG. 7 is a bottom plan view thereof;

FIG. 8 is a cross-sectional view thereof taken along line 8-8 of FIG. 4;

FIG. 9 is a cross-sectional view thereof taken along line 9-9 of FIG. 4;

FIG. 10 is a cross-sectional view taken along line 10-10 of FIG. 2;

FIG. 11 is a cross-sectional view taken along line 11-11 of FIG. 2;

FIG. 12 is a rear isometric cross-sectional view taken along line 12-12 of FIG. 3;

FIG. 13 is a front isometric cross-sectional view similar to FIG. 12;

FIG. 14 is a diagrammatic view of a prism assembly optically connected between a laser emitter assembly and a scope assembly showing the direction of light rays through the optics in accordance with an exemplary embodiment of the invention;

FIG. 15 is an enlarged diagrammatic view of the prism assembly showing various representative angles associated with each prism; and

FIG. 16 is a rear elevational view of the rangefinder scope of the invention representative of a magnified target with superimposed information related to the target and the rangefinder scope in accordance with an exemplary embodiment of the invention.

It is noted that the drawings are intended to depict only typical embodiments of the invention and therefore should not be considered as limiting the scope thereof. It is further noted that the drawings are not necessarily to scale, and therefore relative dimensions or sizes of the illustrated elements can greatly vary. The invention will now be described in greater detail with reference to the accompanying drawings.

### DETAILED DESCRIPTION OF THE INVENTION

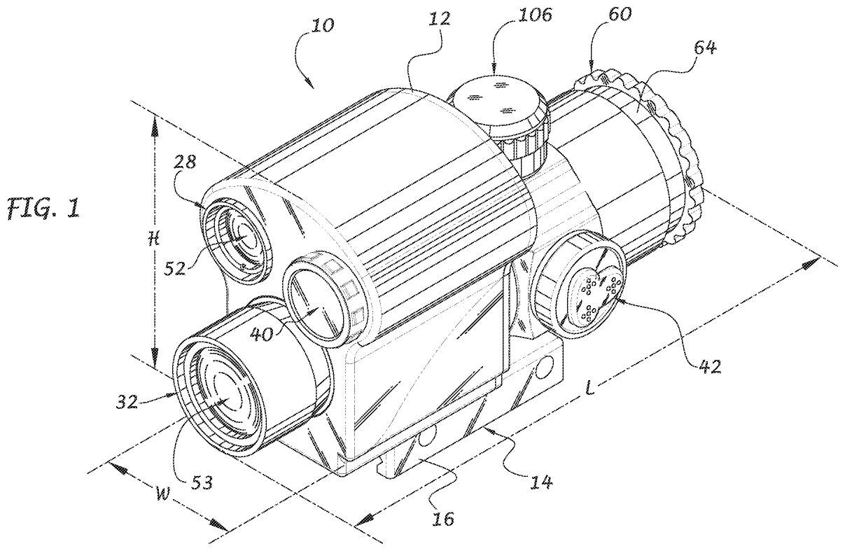

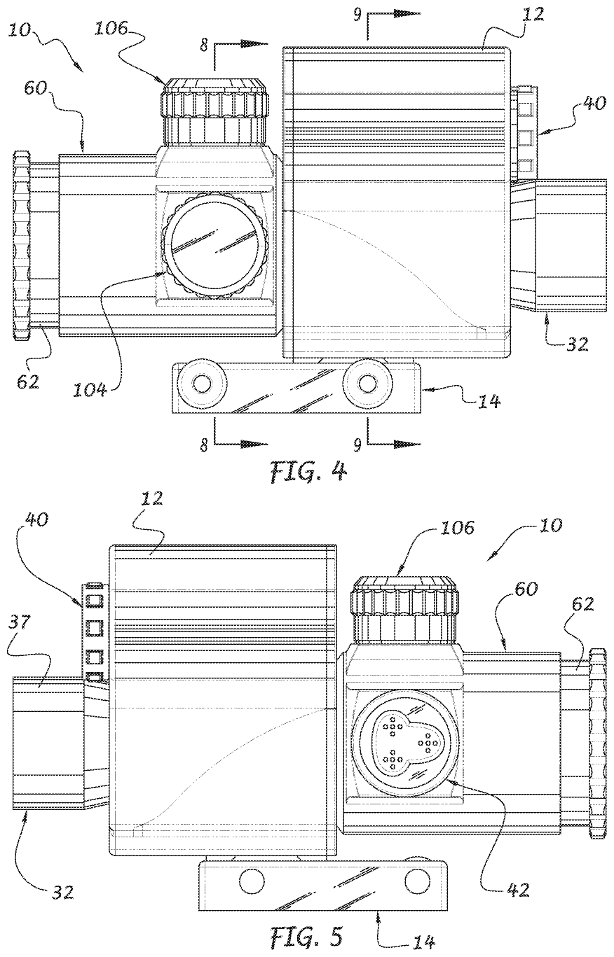

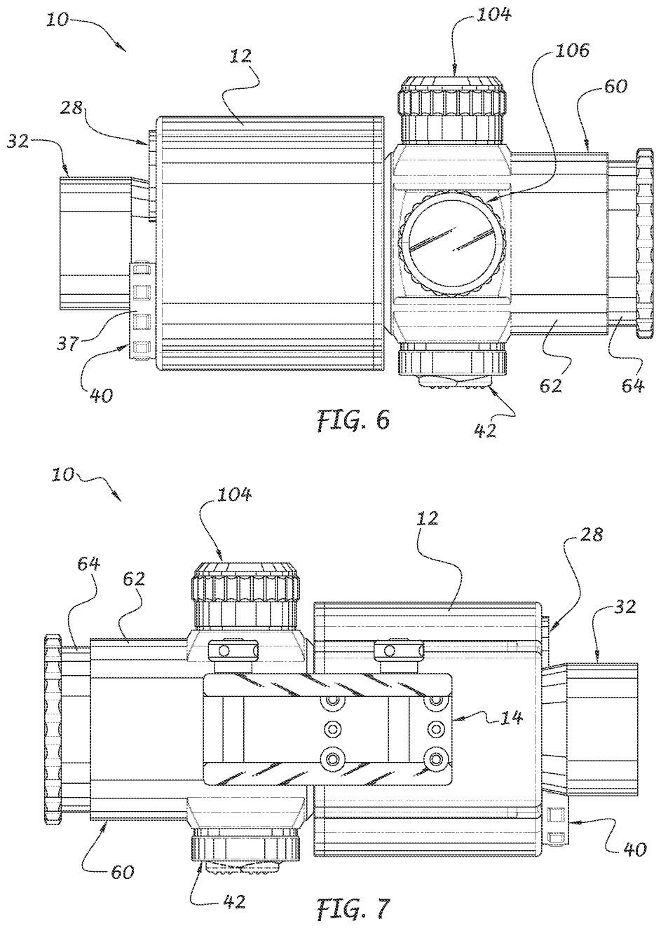

Referring now to the drawings, and to FIGS. 1-7 in particular, a rangefinder scope 10 in accordance with an exemplary embodiment of the present invention is illustrated. The scope 10 has a general outer body 12 and a mounting base 14 extending from the outer body 12 for connecting the rangefinder scope 10 to a crossbow, archery bow, firearm, other projectile launching devices, tripods, as well as other supports, and so on. To that end, the mounting base 14 can be provided with a fixed mounting leg 16 and an adjustable mounting leg 18 slidable toward or away from the first mounting leg 16 when securing the mounting base to or removing the mounting base, respectively, from the crossbow or other device by tightening or loosing mounting screws 20 and 22, in a well-known manner. Each leg 16, 18 includes an inner dovetail-shaped groove 24, 26 respectively, for gripping a similarly shaped dovetail-shaped projection (not shown) on a support or mount of a crossbow or other device. It will be understood that the mounting base does not form part of the present invention, and can therefore be replaced with other mounting bases and/or removed when holding the rangefinder scope 10 by hand for example, without departing from the spirit and scope of the invention.

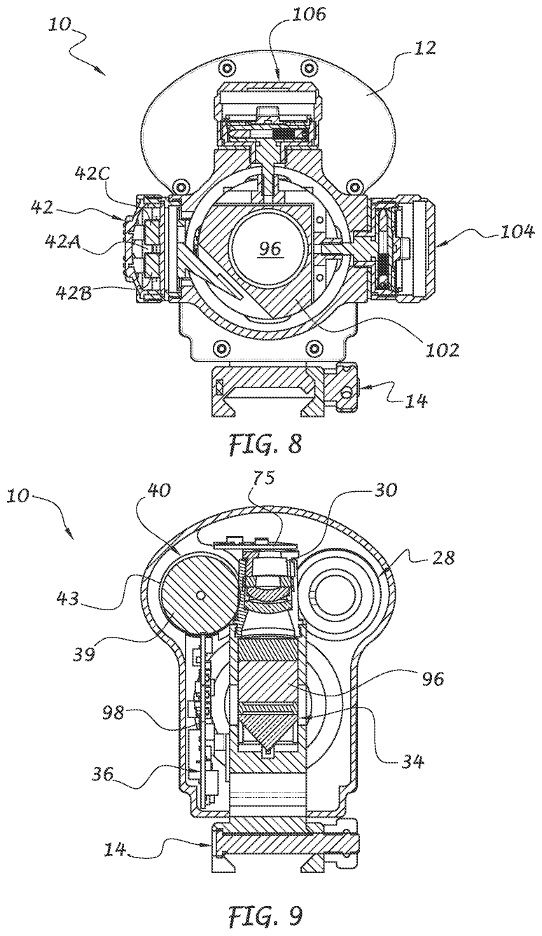

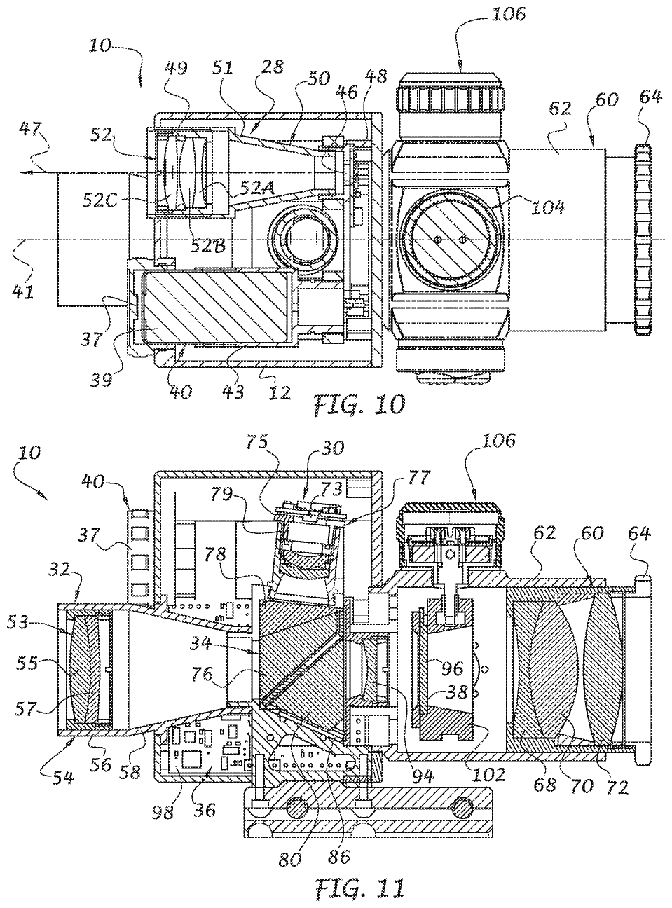

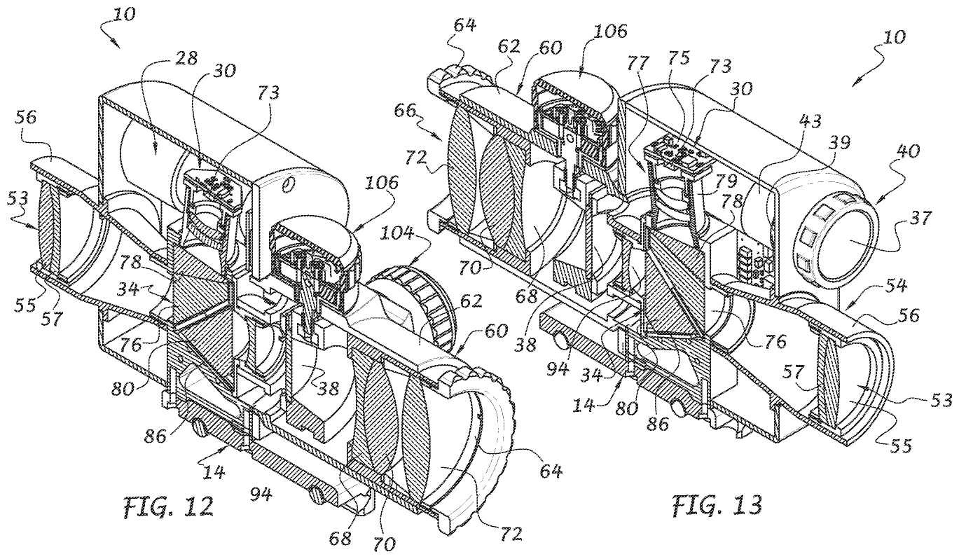

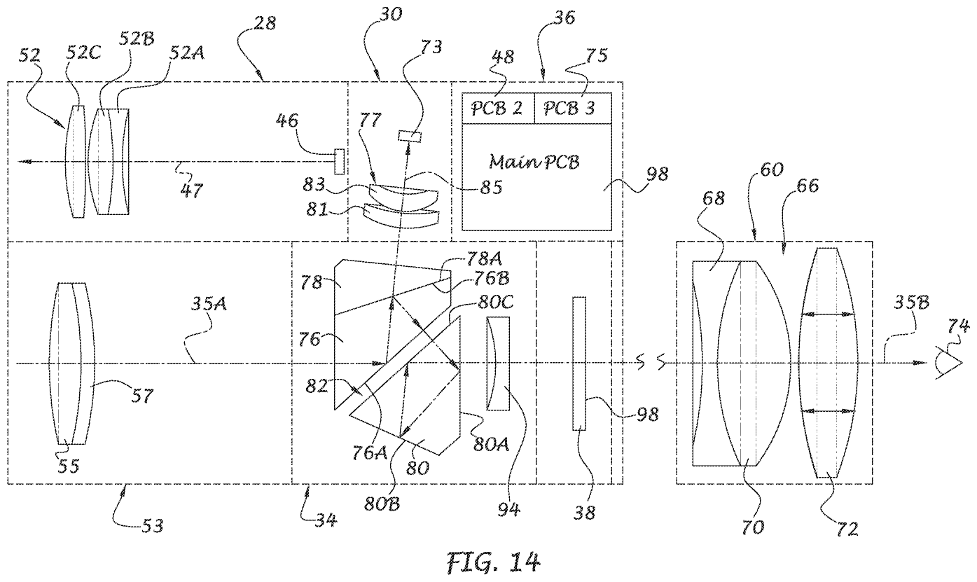

With additional reference to FIGS. 8-14, the rangefinder scope 10 preferably includes an emitter section 28 (FIGS. 10 and 14), a receiver section 30 (FIGS. 10 and 11), an adjustable scope assembly 32, and a prism assembly 34 optically connected between the receiver section 30 and scope assembly 32. An electronics assembly 36 is operably associated with the emitter section 28, the receiver section 30, and a reticle device 38 stationed rearwardly of the prism assembly 34 and in an optical path 35 of the adjustable scope assembly 32. A power supply 40 (FIG. 10) is connected to the electronics assembly 36 via a control switch 42 for selectively providing power to the electronics assembly 36.

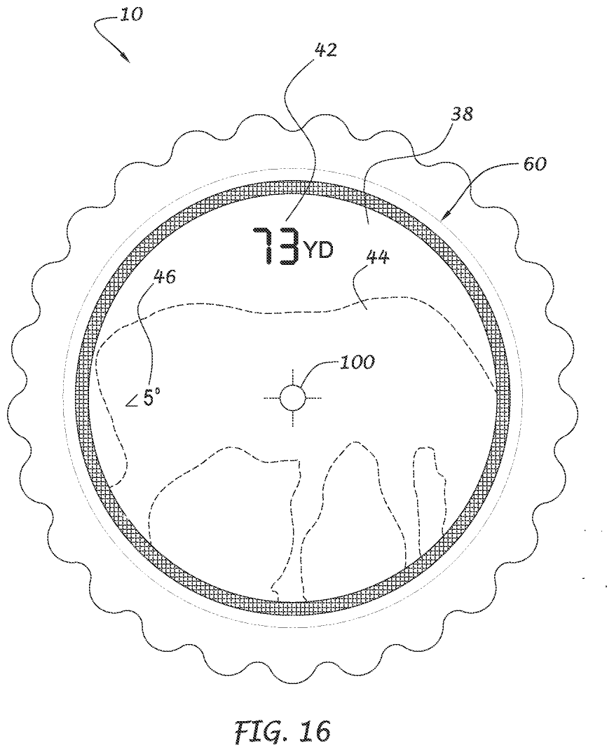

In accordance with an exemplary embodiment of the invention, the control switch 42 includes three momentary push-button switches 42A, 42B, and 42C (FIG. 8) for: 1) selectively powering the electronics assembly via the power supply 40; 2) selectively changing the units of the distance 42 (FIG. 16) displayed on the reticle device 38, as measured between the rangefinder scope 10 and a target 44, for example, so that the user can switch between different measurement units, such as meters, feet, yards, and so on; and 3) selectively displaying an angle or slope 46 on the reticle device 38 of the rangefinder scope 10 with respect to the target 44. In this manner, adjustments can be made when the rangefinder scope 10 is connected to a crossbow (not shown) for example, to compensate for sloping terrain and other factors.

As shown in FIGS. 10 and 14, the emitter section 28 is separate and distinct from the receiver section 30 and preferably includes an emitter 46 that transmits radiant energy toward a distal target when in use. The emitter 46 preferably includes a laser emitting diode 46 that transmits pulses of radiant energy in the near-infrared region of the electromagnetic radiation spectrum. It will be understood that the emitter 46 can transmit radiant energy in the visible light region, ultra-violet light region, or other suitable ranges and/or wavelengths. It will be understood that the emitter 46 is not limited to laser emitting diodes or transmitting pulses of energy, but can include one or more LED's and/or other radiant energy sources capable of being transmitted to, and reflected by, a distal target in a Time-of-Flight (ToF) measurement system. The emitter 46 is connected to a small circuit board 48, which is in turn mounted to a rearward end of an emitter housing 50 having a front cylindrically-shaped segment 49 and a rear generally frustoconically shaped segment 51. A collimating lens assembly 52 is located in a forward end of the emitter housing 50 and includes a first double-concave lens 52A, a second double convex lens 52B in contact with the first lens 52A, and a third plano-convex lens 52C that together ensure radiant energy from the emitter 46 is a uniformly collimated light beam 47 (FIG. 10) when it exits the housing.

The adjustable scope assembly 32 preferably includes a stationary front objective collimating lens assembly 53 located in a front cylindrical segment 56 of an objective lens housing 54. A rear section 58 of the housing 54 is generally frustoconical in shape and converges toward the prism assembly 34. The objective lens assembly 53 preferably includes a positive objective lens 55 and a negative objective lens 57 that together collimate beams of light passing therethrough, including light reflected from the distal target and/or scene, as well as reflected radiant energy from the emitter 46. In this manner, reflected light rays from both the distal scene and the target from various light sources, including natural and artificial light, as well as radiant energy reflected by the target from the emitter 34, overlap in a parallel manner as the reflected light travels rearwardly within the lens housing 54 and toward the prism assembly 34.

The adjustable scope assembly 32 also preferably includes a rear ocular lens assembly 60 that is linearly adjustable with respect to the stationary front objective lens assembly 53, the prism assembly 34, and the reticle 38 to vary the magnification of the distal target or scene without compromising measurement accuracy of the rangefinder scope 10. The rear ocular lens assembly 60 is useful for adjusting the focus of the distal scene and target when viewed in conjunction with the front objective lens assembly 53, and preferably includes an eyepiece frame 62 with a diopter ring 64 that is adjustable with respect to the eyepiece frame 62, and a diopter lens assembly 66 located within the diopter ring 64. The lens assembly 66 preferably includes a double concave lens 68, a double convex lens 70 in contact with the lens 68 to create a predetermined magnification power or diopter, and a double convex lens 72 spaced from the lens 70. Together, the lenses 68, 70 and 72 create a means for adjusting the focus and magnification power when combined with the stationary front objective lens assembly 53 so that the target and/or distal scene can be selectively magnified and viewed through the ocular lens assembly 60.

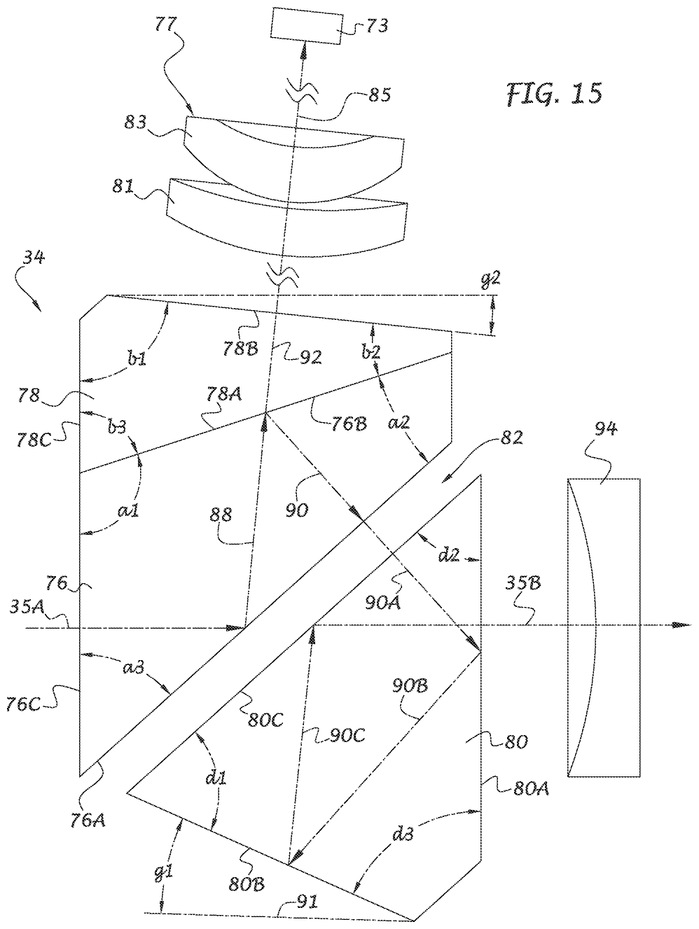

As shown in FIGS. 9 and 12-14, the receiver section 30 preferably includes a receiver 73 mounted on a small receiver circuit board 75 on a tubular housing 79 of a receiver collimating lens assembly 77. The receiver collimating lens assembly 77 includes a first meniscus lens 81 nearest the prism assembly 34 and in close proximity or contact with a second convex-concave lens 83 for collimating the beam 85 of radiant energy at it exits the prism assembly 34 just prior to being detected by the receiver 73. The receiver is preferably in alignment with the beam 85 and thus the central axis of the receiver collimating lens assembly 77 (FIG. 15) for detecting and/or measuring radiant energy reflected by a distal target when the radiant energy is transmitted by the emitter 46.

In accordance with an exemplary embodiment of the invention, the receiver 73 preferably includes a photodiode capable of receiving or detecting one or more pulses of infrared radiant energy when the emitter 46 comprises a laser emitting diode that transmits pulses of radiant energy in the near-infrared region of the electromagnetic radiation spectrum. It will be understood that the receiver 73 can receive or detect radiant energy in the visible light region, ultra-violet light region, or other suitable regions and/or wavelengths. It will be further understood that the receiver 73 is not limited to photodiodes or detecting pulses of energy, but can include a plurality of photodiodes arranged linearly or in an array, one or more phototransistors, photoresistors or LDR's, photodarlington transistors, photothyristors or SCR's, photovoltaic cells, CCD cameras, and so on, as well as any suitable photoelectric device that can measure radiant energy in the near infrared, visible, and ultraviolet regions, and/or other suitable measurement devices in other regions or wavelengths of the electromagnetic spectrum.

When the receiver 73 comprises one or more photodetectors, such as a photodiode, capable of receiving or detecting one or more reflected pulses of infrared radiant energy transmitted by the infrared laser emitting diode 46, the reflected light pulse bends through the collimating lens assembly 53 of the adjustable scope assembly 32, thereby ensuring the reflected pulsed beam of infrared energy is relatively small in diameter at it leaves the collimating lens assembly 53 in a substantially parallel fashion. However, due to manufacturing tolerances, the diameter of the light transmitted by the emitter 45 can vary, as well as the distance from the collimating lens assembly 53 and surface variations on the individual lenses themselves, can cause the pulsed energy beam to diverge. Upon impinging the target, the pulsed light beam is reflected and can be somewhat scattered, especially since the pulsed beam may contact the target at an angle, as well as the relative rough surface of a distal target when compared to the smooth surfaces of the individual lenses 52A, 52B, and 52C of the emitter collimating lens assembly 52.

As the pulsed light beam reflects off of a distal target, which can be up to 500 meters or more away in accordance with the present configuration of an exemplary embodiment of the invention, the light beam can become somewhat scattered as they reflect off targets with rough and/or angled surfaces with respect to the central axis of the pulsed light beam. However, the laser diode 46 and various collimating lens assemblies are configured, in accordance with an exemplary embodiment of the invention, to operate even under challenging atmospheric conditions, thereby ensuring that at least a portion of the reflected pulsed infrared light will return to the rangefinder scope 10, even at distances exceeding 500 meters. As a portion of the reflected light pulse returns, it passes through the front objective collimating lens assembly 53 of the adjustable scope assembly 32 so that the reflected beam 35A of pulsed light is collimated prior to passing through the prism assembly 34, then collimated again, as represented by arrow 85 in FIGS. 14 and 15, as it passes out of the prism assembly and through the receiver collimating lens assembly 77 just prior to being detected by the receiver 73. Once detected, the difference in time between transmission of the light pulse and detection of the reflected light pulse can be determined to measure the distance between the target and the rangefinder scope 10, using well-known Time-of-Flight (ToF) techniques, the subject matter of which will not be further described herein as it does not form part of the present invention. As previously mentioned, the receiver 73 is preferably in alignment with the central axis of the receiver collimating lens assembly 77 (FIG. 15), and thus the collimated reflected pulsed light beam for detecting and/or measuring radiant energy reflected by a distal target when the radiant energy is transmitted by the emitter 46.

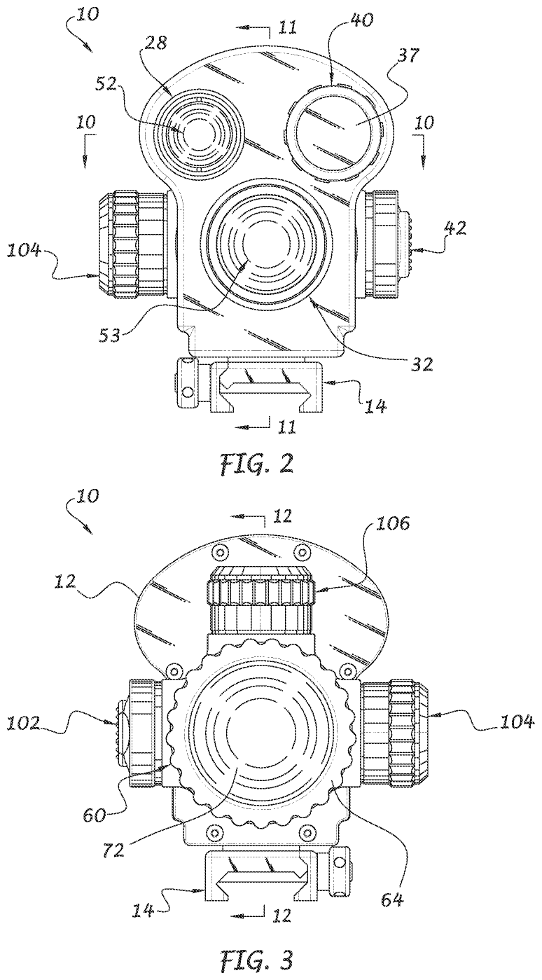

As best shown in FIGS. 2, 9 and 10, the power supply 40 is located above the collimating objective lens assembly 53 of the adjustable scope assembly 32 at approximately the same height as the emitter assembly 28. Likewise, the emitter assembly 28 and power supply 40 are spaced approximately equidistant in a horizontal direction with respect to a longitudinal centerline 41 (FIG. 10) of the rangefinder scope 10, and thus the optical center 35A (FIG. 14) of the objective lens assembly 53. Moreover, the power supply 40 and the emitter assembly 28 are of similar length and diameter, thereby creating a more balanced rangefinder scope with an aesthetic appeal.

The power supply 40 includes a casing 43 received in the housing 12 and a cylindrical battery 39 received in the casing. An end cap 37 twists onto the outer end of the casing 43 to both hold the battery 39 in place and provide a first electrical contact (not labeled) at the forward end of the battery. Likewise, the casing includes a spring contact or the like (not shown) to provide a second electrical contact for powering the electrical assembly 36. With the battery uniquely positioned at the top in accordance with one aspect of the invention, the overall size of the rangefinder scope is more compact than prior art devices where the batter is typically located underneath the rangefinder housing. Adding more to the compactness of the rangefinder scope 10 of the present invention, is the location of the emitter assembly as previously described. In contrast, prior art emitters are located at much lower positions.

With particular reference to FIGS. 14 and 15, the prism assembly 34 optically interfaces between the receiver section 30 and adjustable scope assembly 32. In this manner, the light from the sun and/or artificial light sources reflected on a distal target or scene can be viewed by a user with great clarity while the pulsed radiant energy from the emitter 46, which has been reflected by the target, is also received through the same objective lens assembly 53 and collimated prior to reaching the prism assembly 34 where it is reflected by various surfaces of the prism assembly until the emitted/reflected radiant energy reaches the receiver section 30 for calculating the distance, using well-known Time-of-Flight (ToF) techniques, with great accuracy. Accordingly, the reflective surfaces of the prism assembly 34, together with the refractive index of the prism material(s) and the collimating lens assemblies, cause reflected light from the distal target and scene to be viewed by the eye 74 (FIG. 14) of a user along a first optical pathway 35A between the front collimating objective lens assembly 53 and the prism assembly 36, and along a second optical pathway 35B collinear with the first optical pathway 35A between the prism assembly and the rear ocular lens assembly 60.

The prism assembly 34 preferably includes a first or middle prism 76 with a first reflective surface 76A and a second semi-reflective surface 76B, a second or upper prism 78 with a first reflective surface 78A, and a third or lower prism 80 with a first semi-reflective surface 80A, a second reflective surface 80B, and a third semi-reflective surface 80C. The first and third prisms 76 and 80, respectively, are spaced from each other by a gap 82. A spacer 84 is located partially in the gap 82 and a damping member 86 supports the third prism 80 to prevent vibration in the optics during use and transportation, thereby providing a very compact, robust rangefinder scope that maintains optical stability during use. One or more of the reflective surfaces associated with each prism can be coated or otherwise treated with well-known optical coatings and/or filters that partially reflect light for semi-reflective surfaces or fully reflect light for fully reflective surfaces. Although the prisms are preferably constructed of glass with a high refractive index, the prisms can be constructed of any suitable transparent material, including different glass materials with different indices of refraction, plastics, liquid-filled prisms, and so on, to obtain the desired effects without departing from the spirit and scope of the invention.

As best shown in FIG. 15, the collimated reflected light coming from the collimating objective lens assembly 52 enters the first prism 76 where it is completely reflected by the first reflective surface 76A, as represented by arrow 88. The light 88 then travels through the first prism material until reaching the second surface 76B of the first prism 76 and/or the first surface 78A of the second prism 78, where it is partially reflected or split into a first split light beam 90 traveling in a first direction back through the first prism material, and into a second split light beam 92 in a second direction through the first prism material, as represented by arrow 92. Since the collimated light travels in a direction perpendicular to the first reflective surface 76A, there is no reflection at that surface and the split light travels through the semi-reflective surface 80C of the third prism 80. Likewise, the second split light beam 92A travels through the second prism 78 and through a second non-reflecting surface 78B perpendicular thereto, so that the second split light beam 92 continues to travel in the second direction, toward the receiver collimating lens assembly 77 as previously described. The first split light beam 90 travels through the gap 82 and enters the third prism 80 perpendicularly through the third semi-reflecting surface 80C with no signal loss, as represented by arrow 90A. The first split light beam 90 then travels through the third prism 80 until it reaches the first reflective surface 80A, reflecting off that surface and traveling toward the second reflective surface 80B, as represented by arrow 90B. The first split light beam 90 then travels through the third prism from the second reflective surface toward the third reflective surface 80C of the third prism, as represented by arrow 90C. Subsequently, the first split light beam 90 completely reflects off the third reflective surface 80C of the third prism 80, as represented by arrow 90D, which is coincident with the second optical pathway 35B as previously described, with the resulting image rotated 180 degrees from where it started prior to entering the prism assembly 34, which greatly shortens the optical path and reduces the total length of the system.

With the above-described configuration, ambient light reflected on the target, scenery, or the like, as well as reflected light from artificial light sources that illuminate a distal scene, including a target, is received in the adjustable scope assembly 32 along with the pulsed light beam that has been transmitted by the emitter 46 through the emitter collimating assembly 52 and reflected off the target, through the front objective collimating lens assembly 53 along the first optical pathway 35A, then split into the first split light beam 90 and second split light beam 92, with the first split light beam 90 following the second optical pathway 35B coincident with the first optical pathway 35A, and finally traveling through the rear ocular lens assembly 60 for viewing the target and surrounding environment by the eye 74 of a user substantially distortion free along the split optical path 90 even with a user-selected magnification. Concurrently, the second split light beam 92 includes the reflected light pulse through the second prism 78 and through the receiver collimation assembly 30, and is therefore collimated three times before reaching the receiver 73 for detecting arrival of the transmitted light pulse to thereby calculate the ToF and thus determine the distance between the rangefinder scope 10 and the target.

Along with anti-reflective coatings and the like that can be applied to the surfaces of lens/prism assemblies, anti-phase shifting coatings that can be applied to the surfaces of the prism assembly, one or more films, coatings, filters or the like can be applied to one or more of the interface surfaces 76B and 76A to reduce reflectivity of these surfaces to near infrared radiation for example, while increasing transmission of the near infrared radiation through these surfaces in a known manner, to thereby maximize the infrared light pulse received at the photodiode 73 or the like, while minimizing or eliminating any infrared light that might otherwise travel along the first split pathway to a user.

As shown in FIG. 15, the first prism 76 has a first angle a1 between the second surface 76B and third surface 76C, a second angle a2 between the second surface 76B and first surface 76A, and a third angle a3 between the first surface 76A and the third surface 76C. Likewise, the second prism 78 has a first angle b1 between the second surface 78B and third surface 78C, a second angle b2 between the second surface 78B and first surface 78A, and a third angle b3 between the first surface 78A and the third surface 78C. The third prism also has a first angle d1 between the second surface 80B and third surface 80C, a second angle d2 between the third surface 80C and first surface 80A, and a third angle d3 between the first surface 80A and the second surface 80C. Although other surfaces are present for all three prisms, the reflected light pulse and ambient light traveling through the prisms are not directly impacted by the other surfaces, and therefore the surfaces can be projected toward a single vertex for each of the angles a2, b1, and d3 so that each prism can be thought of as a triangle having three sides and three inner angles defining the relationship between those sides and thus the relative relationship between the reflective/refractive surfaces of the prisms, as illustrated in FIG. 15. In this manner, the angle sum theorem for interior angles of triangles can be applied, i.e. all angles of an imaginary three-sided prism (keeping in mind that the truncated portion(s) of each prism can be extended to form an imaginary vertex or angle) when summed together equal 180°.

In accordance with an exemplary embodiment of the invention, and by way of example only, it being understood that the values of the inner angles of each prism along with the length of each prism surface can vary without departing from the spirit and scope of the invention, it has been found that the inner angles of the prisms with the following values provide several advantages as set forth herein:

| PRISM # | ANGLE 1 | ANGLE 2 | ANGLE 3 |
|---|---|---|---|
| 76 | a₁ ≈ 108 | a₂ ≈ 24 | a₃ ≈ 48 |
| 78 | b₁ ≈ 84 | b₂ ≈ 24 | b₃ ≈ 72 |
| 80 | d₁ ≈ 66 | d₂ ≈ 48 | d₃ ≈ 66 |

Moreover, the particular angle of the prisms with respect to horizontal and/or vertical reference planes establish the orientation of the prism assembly for ensuring the optical pathways are correctly established through the prisms. Accordingly, a first outer angle g1 can be defined by a first or lower horizontal reference line or plane 91 and the second surface 80B of the third prism 80. Likewise, a second outer angle g2 can be defined by a second or upper horizontal reference line or plane 93 and the second surface 78B of the second prism 78. In accordance with an exemplary embodiment of the invention, and by way of example only, it being understood that the values of the first and second angles, and thus the orientation of the prism assembly 34, can vary without departing from the spirit and scope of the invention, the first outer angle g1≈24° and the second outer angle g2≈6°. It will be understood that the particular angular values of the prism assembly can vary without departing from the spirit and scope of the invention.

As best shown in FIGS. 11-15, a plano-concave lens 94 is positioned rearwardly of the prism assembly 34. The lens 94 can help reduce any spherical aberration and coma that may be present with the collimated light exiting along the optical pathway 35B.

The reticle device 38, as briefly described above, is positioned rearwardly of the lens 94 and preferably comprises a transparent display panel 96 connected to the main PCB 98 of the electronics assembly 36, as well as the control switch unit 42, for selectively displaying distance information 42 (FIG. 16) and/or angle information 46 with respect to a target 44 to a user 44 (FIG. 14), for example, which information appears to be superimposed on the target and scenery surrounding the target in a non-obtrusive manner to maximize the view through the rangefinder device.

A central sight aperture 100 (FIG. 16) is shown as generally circular in shape with a predetermined diameter for aligning the rangefinder scope with a desired target. It will be understood that the aperture can be of any useful shape, pattern or design, and can be affixed to the display panel 96 in any well-known manner.

Referring now to FIGS. 8 and 11-13, the reticle device 38 is mounted in a floating frame 102 for adjusting a position of the sight aperture 100 with respect to the optical pathway 35B. To that end, a first knob assembly 104 interacts with the side of the frame 102 for adjusting a lateral or windage position of the frame and thus the sight aperture 100. Likewise, a second knob assembly 106 is operably connected to the frame 102 for adjusting a vertical or height position of the frame and thus the sight aperture 100. The construction and operation of the first and second knob assemblies are well known and will not be further described herein.

With reference to FIGS. 1, 10, and 11, and in accordance with a preferred embodiment of the invention, the particular configuration of the prism assembly 34 and collimating lens assemblies 52, 53, and 77, as described above, greatly reduce the overall size and weight of the rangefinder scope 10 when compared to prior art devices.

By way of example, with the above-described exemplary configuration, the overall length of the rangefinder scope 10, including the ocular lens assembly 60 projecting rearwardly from the housing 12 and the front objective lens assembly 53 projecting forwardly therefrom is approximately L≈5.5 inches (140 mm), while the width is approximately W≈2.4 inches (61 mm) without the protruding switch assembly 42 and windage adjusting knob assembly 106, and the overall height is approximately H≈3.0 inches (76 mm) without the mounting bracket 14. Thus, the overall size of the rangefinder scope 10 has been greatly reduced when compared to prior art systems due to the use of a prism assembly in accordance with the invention, in conjunction with the lens assemblies, the placement of the power supply 40 above the objective lens assembly 53 and spaced equidistant therefrom with the emitter assembly 28, thereby creating a more balanced feel and aesthetic appeal.

Although some prior art rangefinder devices may use prisms, such devices are usually handheld rangefinders or binoculars that, although typically small in size, they are not intended for use in aiming/targeting as the precision level needed for more precise activities cold not be achieved until the present invention. In contrast, the rangefinder scope 10 of the present invention uses a collimating objective lens assembly 53 in tandem with the prism assembly 34. Moreover, the receiver collimation lens assembly 77 ensures that refracted light rays that exit the prism assembly are brought back together to form a coherent column of light directed to the photodiode or other photosensitive device as discussed above. Thus, in accordance with the present invention, greater accuracy in optically determining the distance between a target and a user has been achieved by ensuring that refracted light exiting the second prism 78 is collimated once again, thereby increasing the measurement precision of the receiving photodiode. With the above-described embodiment of the invention given by way of example, the rangefinder scope 10 can measure over distances of 500 meters with +/−0.25 meter accuracy.

It will be understood that the present invention is not limited to the particular embodiments disclosed, but also covers modifications, features, shapes, and configurations within the spirit and scope of the invention as defined by the appended claims.

What is claimed is:

1. A rangefinder scope comprising:
an emitter assembly for transmitting radiant energy toward a distal target;
a first collimating lens assembly for receiving and collimating the reflected radiant energy;
a prism assembly optically connected to the first collimating lens assembly for receiving the collimated reflected radiant energy; and
a receiver assembly in optical communication with the prism assembly for detecting the radiant energy reflected by the target to thereby calculate a distance between the rangefinder scope and the target.

2. A rangefinder scope according to claim 1, and further comprising a second collimating lens assembly located between the prism assembly and the receiver assembly to further collimate the collimated reflected radiant energy.

3. A rangefinding scope according to claim 2, and further comprising a third collimating lens assembly positioned in an optical pathway of the emitter assembly to collimate the radiant energy before it reaches the distal target so that the radiant energy is columnated three times prior to being received by the receiver assembly to thereby determine an accurate distance between the rangefinding scope and the distal target.

4. A rangefinder scope according to claim 3, wherein the emitter assembly is spaced from the receiver assembly.

5. A rangefinder scope according to claim 2, wherein the first collimating lens assembly comprises an objective collimating lens assembly.

6. A rangefinder scope according to claim 5, and further comprising:
a scope housing with a first end portion and a second end portion;
the objective lens assembly being positioned at the first end portion and having a first optical pathway;
an ocular lens assembly positioned at the second end portion spaced from the objective lens assembly and having a second optical pathway;
wherein the prism assembly is positioned in the scope housing between the objective lens assembly and the ocular lens assembly.

7. A rangefinding scope according to claim 6, wherein the second collimating lens assembly is positioned in the scope housing between the prism assembly and the receiver assembly and has a third optical pathway different from the first and second optical pathways.

8. A rangefinding scope according to claim 7, and further comprising a third collimating lens assembly positioned in an optical pathway of the emitter assembly to collimate the radiant energy before it reaches the distal target so that the radiant energy is columnated three times prior to being received by the receiver assembly to thereby determine an accurate distance between the rangefinding scope and the distal target.

9. A rangefinding scope according to claim 8, wherein the first and second optical pathways are coaxial.

10. A rangefinding scope according to claim 8, wherein the prism assembly comprises:
a first prism with a first reflective surface and a first semi-reflective surface spaced therefrom;
a second prism located above the first prism and having a second reflective surface; and
a third prism located below the first prism and having a second semi-reflective surface, a third reflective surface spaced therefrom, and a third semi-reflective surface adjacent to the third reflective surface;
wherein ambient light as well as the radiant energy from the emitter assembly reflected at least off the distal target are received through the front objective collimating lens assembly along the first optical pathway, then split into a first split light beam and a second split light beam in the first prism via the first reflective surface and first semi-reflective surface, with the first split light beam also reflecting off the second semi-reflective surface, the third reflective surface, and the third semi-reflective surface of the third prism following the second optical pathway through the rear ocular lens assembly; and
further wherein the second split light beam comprising the radiant energy from the emitter assembly exits the second prism and passes through the second collimating lens assembly along the third optical pathway and impinges on the receiver assembly for determining a distance between the rangefinder scope and the distal target.

11. A rangefinding scope according to claim 10, wherein the first and second optical pathways are coaxial.

12. A rangefinding scope according to claim 10, wherein the first and third prisms are spaced from each other by a gap.

13. A method of determining the distance to a distal target, the method comprising:
emitting radiant energy toward the distal target causing the radiant energy to be reflected therefrom;
collimating the reflected radiant energy and ambient light reflected at least by the distal target along a first optical pathway;
splitting the columnated reflected radiant energy and the columnated ambient light into a first split light beam and a second spit light beam, respectively;
directing the first split light beam along a second optical pathway through an ocular lens for optically viewing at least the distal target;
collimating the second split light beam along a third optical pathway; and
determining the distance by calculating a time of flight difference between the emitted radiant energy and the reflected radiant energy.

14. A method according to claim 13, wherein the step of emitting radiant energy comprises collimating the radiant energy prior to reflecting the radiant energy by the distal target, so that the radiant energy is collimated three times prior to the step of determining the distance.

15. A method according to claim 14, wherein the step of splitting the columnated reflected radiant energy and the columnated ambient light comprises providing a prism assembly with reflective and semi-reflective surfaces.

16. A method according to claim 15, wherein the step of emitting radiant energy comprises emitting pulses of light toward the distal target.

17. A method according to claim 13, wherein the first optical pathway and the second optical pathway are coincident.

18. A method according to claim 13, wherein the step of emitting radiant energy comprises emitting pulses of light toward the distal target.
